(19) United States
(12) Patent Application Publication
(10) Pub. No.: US 2009/0184951 A1
(43) Pub. Date: Jul. 23, 2009

(54) PLASMA DISPLAY DEVICE AND METHOD OF DRIVING THE SAME

(76) Inventor: Yong-Jin Kim, Suwon-si (KR)

Correspondence Address: CHRISTIE, PARKER & HALE, LLP, PO BOX 7068, PASADENA, CA, 91109-7068, US

(21) Appl. No.: 12/236,284

(22) Filed: Sep. 23, 2008

(30) Foreign Application Priority Data
Sep. 28, 2007 (KR) 10-2007-0098284

(51) Int. Cl. G09G 5/00; G09G 3/28

(52) U.S. Cl. 345/212; 345/60

(57) ABSTRACT

A plasma display device includes a plasma display panel and a controller for receiving a digital image signal corresponding to an image to be displayed during a frame. The controller time divides a frame into a plurality of subfields, generates control signals for driving the respective subfields at an initialization period, an address period, and a sustain discharging period, and generates switching signals corresponding to the respective subfields. The plasma display device also includes a driver for generating different levels of voltages in accordance with the switching signals, and for providing display data with the generated voltages in accordance with the control signals to the plasma display panel. The plasma display device may also generate switching signals corresponding to the temperature sensed by a temperature sensor.

### CROSS-REFERENCE TO RELATED APPLICATIONS

This application claims priority to and the benefit of Korean Patent Application No. 10-2007-0098284, filed on Sep. 28, 2007, in the Korean Intellectual Property Office, the entire content of which is incorporated herein by reference.

### BACKGROUND

1. Field of the Invention

The present invention relates to a plasma display device and a method of driving the same.

2. Description of the Related Art

A plasma display panel (PDP) is a flat panel display that displays characters or images using plasma generated by gas discharge. The PDP has higher brightness and emission efficiency and a larger viewing angle than a liquid crystal display (LCD) or a field emission display (FED). Therefore, the PDP is in the spotlight as a display for replacing a cathode ray tube (CRT).

The PDP is divided into a DC type PDP and an AC type PDP in accordance with the structure of pixels arranged in a matrix and the waveform of a driving voltage. In the DC type PDP, all of the electrodes are exposed to a discharge space so that the charges move directly between corresponding electrodes. On the other hand, in the AC type PDP, at least one electrode among the corresponding electrodes is surrounded by dielectric material so that the charges do not move directly between the corresponding electrodes.

### SUMMARY OF THE INVENTION

In exemplary embodiments of the present disclosure is provided a plasma display device and a method of driving the same.

In an exemplary embodiment of the present disclosure, there is provided a plasma display device, wherein the plasma display device includes a PDP, a controller for receiving a digital image signal of an image to be displayed on the plasma display panel during a frame, for time dividing the frame into a plurality of subfields, for generating control signals for driving the plasma display panel during an initialization period, an address period, and a sustain discharging period of each of the plurality of subfields, and for generating switching signals corresponding to respective said subfields, and a driver for generating different levels of voltages in accordance with the switching signals, and for providing display data of the image with the generated voltages in accordance with the control signals to the plasma display panel.

The plasma display panel may include pixels formed by a plurality of first electrodes, a plurality of second electrodes, and a plurality of third electrodes, the third electrodes crossing the first and second electrodes.

The controller may be configured to generate the switching signals in accordance with a number of sustain pulses to be applied to the plasma display panel during the sustain discharging period of the subfields.

The driver may include a voltage source, at least one voltage dropping unit coupled with the voltage source, a plurality of switches respectively coupled with the voltage source and the at least one voltage dropping unit, and selectively driven by the switching signals, and a driving circuit for receiving the control signals and for generating the display data with voltage from the voltage source to be transmitted through the plurality of switches.

The at least one voltage dropping unit may include at least two voltage dropping units having different amounts of voltage drops.

The at least one voltage dropping unit may include a Zener diode, a transient voltage suppressor (TVS) diode, or a resistor.

A voltage of a level that is inversely proportional to a number of sustain pulses applied to the plasma display panel during the sustain discharging period of each of the plurality of subfields may be generated in response to the switching signals.

The plasma display device may further include an image processor for receiving an analog image signal and for outputting the digital image signal.

In another exemplary embodiment of the present disclosure, there is provided a method of driving a plasma display device comprising a plasma display panel, wherein the method includes time dividing a frame of a multi-gray level image into a plurality of subfields, displaying the multi-gray level image by driving the plasma display panel during an initialization period, an address period, and a sustain discharging period of each of the plurality of subfields, and providing display data if the image with different levels of voltages in accordance with the subfields to the plasma display panel.

The voltage levels of the display data may be inversely proportional to a number of sustain pulses applied to the plasma display panel during the sustain discharging period of each of the subfields.

In another exemplary embodiment of the present disclosure, there is provided a method of driving a plasma display device comprising a plasma display panel, wherein the method includes time dividing a frame of a multi-gray level image into first through nth subfields, displaying the multi-gray level image by driving the plasma display panel during an initialization period, an address period, and a sustain discharging period of each of the first through nth subfields, providing first display data of the image with a first voltage to first through n-m subfields of the frame to the plasma display panel, and providing second display data of the image with a second voltage to m+1 through nth subfields of the frame to the plasma display panel.

A number of sustain pulses applied to the plasma display panel during the sustain discharging period of the nth subfield may be greater than a number of sustain pulses applied to the plasma display panel during the sustain discharging period of the first subfield.

The first voltage may be higher than the second voltage.

In another exemplary embodiment of the present disclosure, there is provided a plasma display device, wherein the plasma display device includes a plasma display panel, a temperature sensor for sensing temperature of the plasma display panel, a controller for receiving a digital image signal of an image to be displayed on the plasma display panel during a frame, for time dividing the frame into a plurality of subfields, for generating control signals for driving the plasma display panel during an initialization period, an address period, and a sustain discharging period of each of the plurality of subfields, and for generating switching signals corresponding to the temperature sensed by the temperature sensor, and a driver for generating different levels of voltages in accordance with the switching signals, and for providing display data of the image with the generated voltages in accordance with the control signals to the plasma display panel.

The plasma display panel may include pixels formed by a plurality of first electrodes, a plurality of second electrodes, and a plurality of third electrodes, the third electrodes crossing the first and second electrodes.

The driver may include a voltage source, at least one voltage dropping unit coupled with the voltage source, a plurality of switches respectively coupled with the voltage source and the at least one voltage dropping unit, and selectively driven by the switching signals, and a driving circuit for receiving the control signals and for generating the display data with voltages to be transmitted through the plurality of switches.

The at least one voltage dropping unit may include at least two voltage dropping units having different amounts of voltage drops.

The voltage dropping unit may include a Zener diode, a TVS diode, or a resistor.

The plasma display device may further include an image processor for receiving an analog image signal and for outputting the digital image signal.

In another exemplary embodiment of the present disclosure, there is provided a method of driving a plasma display panel, wherein the method includes sensing temperature of the plasma display panel, and providing display data with voltages of different levels in accordance with the sensed temperatures to the plasma display panel.

The first display data with a first voltage may be provided to the plasma display panel when the sensed temperature is less than or equal to a reference temperature, and second display data with a second voltage that is higher than the first voltage may be provided to the plasma display panel when the sensed temperature is greater than the reference temperature.

### BRIEF DESCRIPTION OF THE DRAWINGS

These and/or other embodiments and features of the invention will become apparent and more readily appreciated from the following description of certain exemplary embodiments, taken in conjunction with the accompanying drawings of which:

FIG. 1A is a simplified perspective view illustrating an exemplary facing discharge type PDP;

FIG. 1B is a simplified perspective view illustrating an exemplary surface discharge type PDP;

FIG. 2 is a timing diagram of a unit frame for displaying multi-gray levels of an exemplary PDP;

FIG. 3 illustrates capacitance in an exemplary PDP;

FIG. 4 is a block diagram illustrating a plasma display device according to a first embodiment of the present invention;

FIG. 5 is a circuit diagram illustrating the address driving unit illustrated in FIG. 4;

FIG. 6A is a simplified perspective view illustrating an example of the PDP of FIG. 4;

FIG. 6B is a sectional view illustrating the pixel of FIG. 6A;

FIGS. 7, 8A, and 8B illustrate waveforms for describing the operation of the plasma display device according to an embodiment of the present invention;

FIG. 9 is a block diagram illustrating a plasma display device according to a second embodiment of the present invention; and

FIG. 10 is a circuit diagram illustrating the address driving unit of FIG. 9.

### DETAILED DESCRIPTION

Hereinafter, certain exemplary embodiments according to the present invention will be described with reference to the accompanying drawings. Here, when a first element is described as being coupled to a second element, the first element may be directly coupled to the second element or alternatively, may be indirectly coupled to the second element via a third element. Further, some of the elements that are not essential to the complete understanding of the invention are omitted for clarity. Also, like reference numerals refer to like elements throughout.

The present invention now will be described more fully with reference to exemplary embodiments of the invention. This invention may be embodied in many different forms and should not be construed as being limited to the embodiments set forth herein; rather, these embodiments are provided so that this disclosure will fully convey the concept of the invention to those skilled in the art.

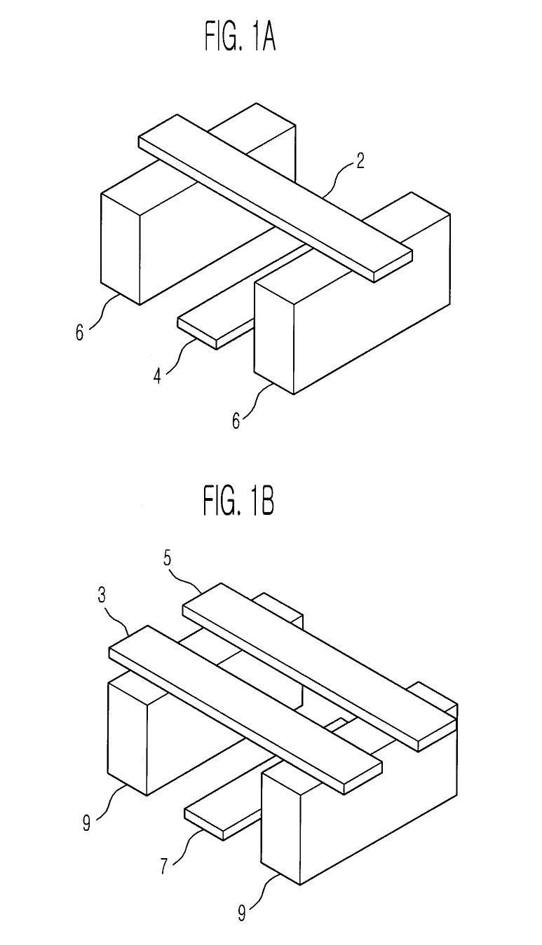

A PDP is divided into a facing discharge type PDP and a surface discharge type PDP in accordance with a method of forming electrodes for discharge. In the facing discharge type PDP, as illustrated in FIG. 1A, address discharge for selecting a pixel and sustain discharge for sustaining discharge occur between a scan electrode (a positive electrode) 2 and an address electrode (a negative electrode) 4. In the surface discharge type PDP, as illustrated in FIG. 1B, address discharge for selecting a pixel occurs between an address electrode 7 and a scan electrode 3 that cross each other and sustain discharge for sustaining discharge occurs between the scan electrode 3 and a sustain electrode 5. Sealed up discharge spaces between barrier ribs 6 or barrier ribs 9 are filled with a gas to prevent cross talk in which the light generated during concurrent discharges affects adjacent pixels.

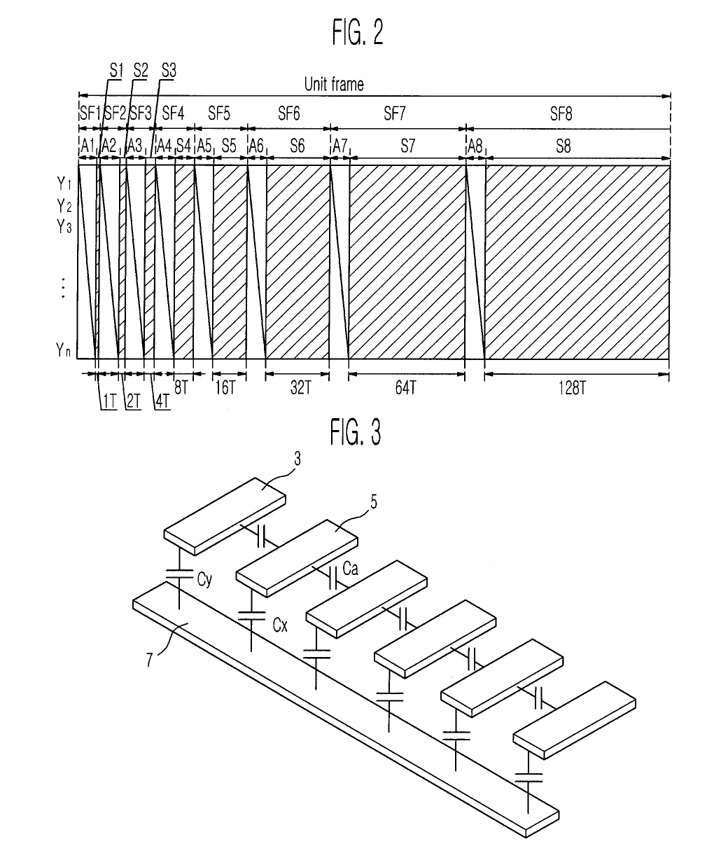

In the PDP having the above structure, as illustrated in FIG. 2, a unit frame is divided into a plurality of subfields to display a multi-gray level image by a time division driving method. Each subfield is divided into an initializing period for making the charge state of a pixel uniform, an address period for accumulating wall charges in a pixel to be driven, and a sustain discharging period for sustaining discharge to display the multi-gray scale image to be driven.

FIG. 2 is a timing diagram for displaying multi-gray levels of an exemplary AC type PDP. One unit frame is time divided into eight subfields SF1, . . . , and SF8 and the subfields SF1, . . . , and SF8 include address periods A1, . . . , and A8 and sustain discharging periods S1, . . . , and S8, respectively.

In the address period A1, . . . , and A8, display data are applied to address electrode lines and scan signal pulses are sequentially applied to scan electrode lines. As a high level display data voltage V_{A} is applied to the scan electrode lines while the scan signal pulses are applied, wall charges are formed in corresponding pixels by the address discharge and are not formed in the other pixels.

In the sustain discharging periods S1, . . . , and S8, a sustain pulse is applied to all of the scan electrode lines and the sustain electrode lines so that display is achieved by the discharge in the pixels where the wall charges are formed.

In the above-described PDP, when the operation of each subfield is performed, as illustrated in FIG. 3, since the discharge spaces between the scan electrode 3 and the sustain electrode 5, and the scan and sustain electrodes 3 and 5 and the address electrode 7 serve as capacitive load, capacitance exists. Therefore, power loss caused by the capacitance, that is, reactive power consumption as well as power consumption for the address discharge, is required. The inefficient power consumption is generated by the voltage applied to the address electrode 7 and the charge and discharge of a capacitor. When the inefficient power consumption increases, the reliability of a driving circuit deteriorates and power consumption to brightness efficiency deteriorates when an address operation is performed to display many moving pictures.

The inefficient power consumption can be expressed by the following Equation 1.

P=fCV² [EQUATION 1]

wherein, f, C, and V represent frequency, capacitance, and a voltage applied to the address electrode 7, respectively, and the capacitance C is expressed by the following Equation 2.

C=C_{X}+C_{Y}+Cₐ [EQUATION 2]

wherein, C_{X}, C_{Y}, and Cₐ represent capacitance between the address electrode 7 and the sustain electrode 5, capacitance between the address electrode 7 and the scan electrode 3, and capacitance between the scan electrode 3 and the sustain electrode 5, respectively.

The power consumption generated in an address process is caused by a change in data among the address electrode 7 lines rather than the load amount of an image. Therefore, as illustrated in the P=fCV² Equation 1, the power consumption is proportional to the frequency f and the capacitance C and the square of the voltage V. Therefore, in order to reduce the power consumption, it is more effective to reduce the voltage V rather than the frequency f and the capacitance C. However, reducing the data voltage V_{A} causes a reduction in a discharge margin, thereby increasing the chance to generate erroneous discharge. Therefore, development of a new technology to drop the inefficient power consumption while sustaining a uniform discharge margin is desired.

In the plasma display device, the data voltage V_{A} is an important factor that determines a discharge state. A discharge delay can be generated in accordance with the level of the data voltage V_{A}. When discharge of a desired amount is not performed during the address period, sufficient wall charges are not generated in the sustain discharging period. However, the discharge state can be changed in accordance with the presence of priming particles in the discharge spaces. In a low gray level where the number of sustain pulses included in the sustain discharging period of a subfield, priming effect is low. When the number of sustain pulses is large, the priming effect is high.

Therefore, according to an embodiment of the present invention, a high data voltage V_{A} is used in a subfield where the number of sustain pulses is small, and a low data voltage V_{A} is used in a subfield where the number of sustain pulses is large. Therefore, the display data having different levels of voltages in accordance with different subfields are supplied to the PDP.

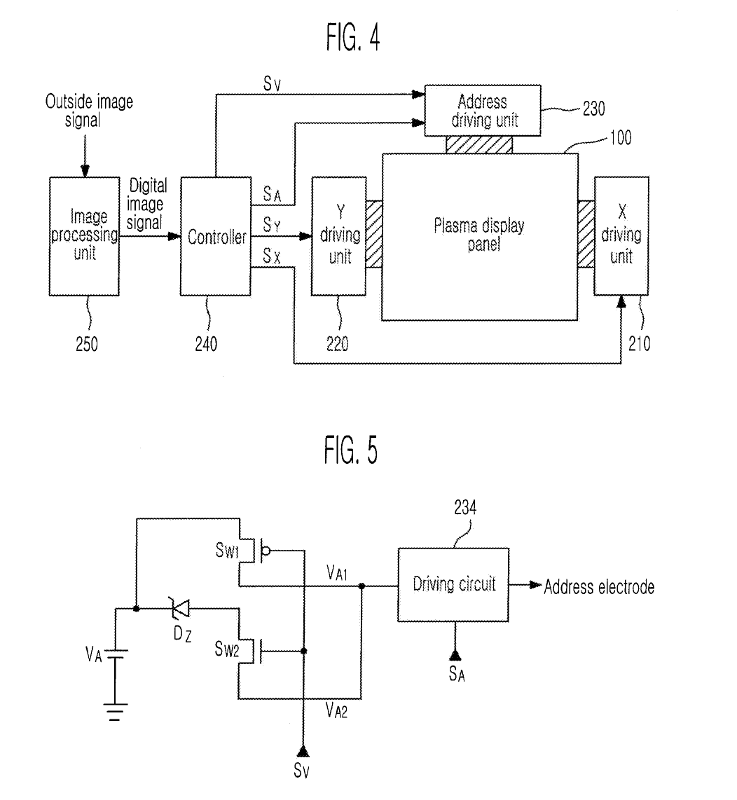

FIG. 4 is a block diagram illustrating a plasma display device according to a first embodiment of the present invention.

An X driver (i.e., driving unit) 210 is coupled with the sustain electrode lines of a PDP 100. A Y driver (i.e., driving unit) 220 is coupled with the scan electrode lines. An address driver (i.e., address driving unit) 230 is coupled with the address electrode lines.

An image processor (i.e., image processing unit) receives analog video signals from the outside to output digital video signals. For example, the image processor 250 outputs red (R), green (G), and blue (B) image data of eight bits, clock signals, and vertical and horizontal synchronizing signals. A controller 240 receives the image data and the synchronizing signals from the image processor 250 and time divides a unit frame into a plurality of subfields. The controller 240 outputs control signals S_{X}, S_{Y}, and S_{A} for dividing each subfield into the initializing period, the address period, and the sustain discharging period to drive the subfields. Here, the controller 240 outputs a switching signal S_{V} for supplying the data voltage V_{A} of a corresponding level in accordance with a subfield to the address driver 230.

The X driver 210 processes the control signal S_{X} supplied by the controller 240 to apply the processed control signal to the sustain electrode lines. The Y driver 220 processes the control signal S_{Y} supplied by the controller 240 to apply the processed control signal to the scan electrode lines. In addition, the address driver 230 processes the control signal S_{A} supplied by the controller 240 to apply display data signals to the address electrode lines. Here, as illustrated in FIG. 5, the address driver 230 supplies a first data voltage V_{A1} or a second data voltage V_{A2} to a driving circuit 234 in accordance with the switching signal S_{V} so that the display data signal having the data voltage V_{A1} or V_{A2} of a corresponding level is applied to the address electrode lines in accordance with the control signal S_{A}.

FIG. 5 is a circuit diagram illustrating an example of the address driver 230 of FIG. 4. The address driver 230 includes at least one voltage dropping unit D_{Z} coupled with the voltage source V_{A}, a plurality of switching units S_{W1} and S_{W2} coupled with the voltage source V_{A} and the voltage dropping unit D_{Z} to be selectively driven in accordance with the switching signal S_{V}, and the driving circuit 234 that receives the control signal S_{A} to generate the display data signal having the voltage V_{A1} or V_{A2} transmitted through the switching units (i.e., switches) S_{W1} and S_{W2}. As can be seen in FIG. 5, the switches S_{W1} and S_{W2} in one embodiment are PMOS and NMOS transistors, respectively. In other embodiments, the switches S_{W1} and S_{W2} may be any other suitable type of device as long as they alternately turn on and off.

When the first switching unit S_{W1} is turned on by the switching signal S_{V} supplied by the controller 240, the first data voltage V_{A1} supplied by the voltage source V_{A} is transmitted to the driving circuit 234. When the second switching unit S_{W2} is turned on by the switching signal S_{V}, the second data voltage V_{A2} that is lower than the first data voltage V_{A1} by the Zener voltage dropped by the voltage dropping unit D_{Z} is transmitted to the driving circuit 234. For example, when the voltage V_{A} of 70V is supplied by a power source supplying apparatus (SMPS) and 20V is dropped by the voltage dropping unit D_{Z}, the first data voltage V_{A1} is 70V, however, the second data voltage V_{A2} is 50V.

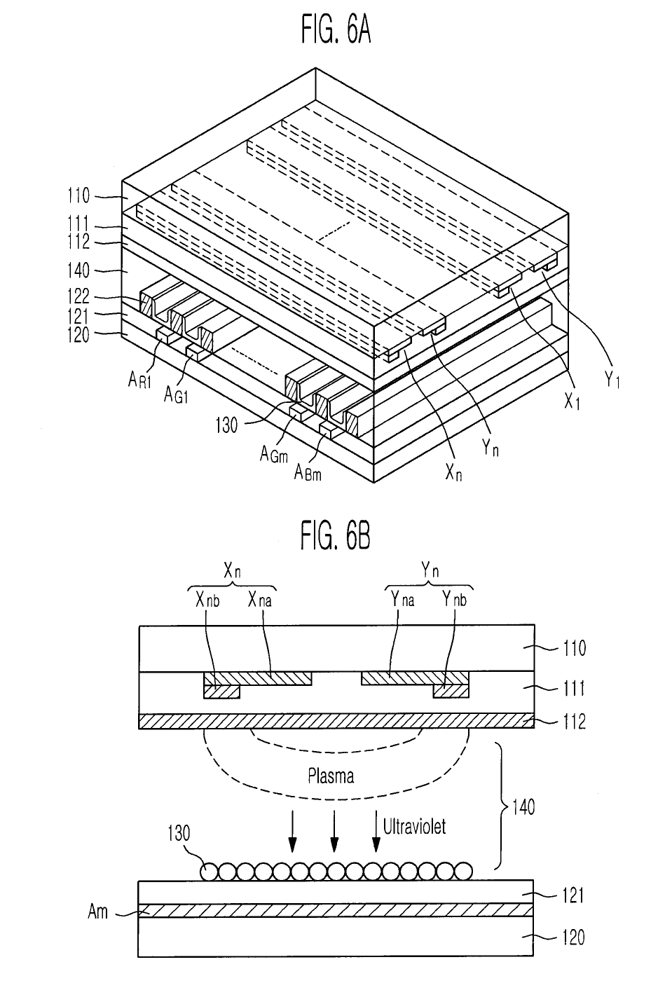

FIGS. 6A and 6B are a perspective view and a sectional view for describing an example of the PDP 100 of FIG. 4, in which a three-electrode surface emission type PDP is illustrated.

A plurality of sustain electrode lines X₁, . . . , and Xₙ and scan electrode lines Y₁, . . . , and Yₙ that are covered with a dielectric substance 111 and a protecting layer 112 are formed on a first substrate 110 in parallel. The sustain electrode lines X₁, . . . and Xₙ and the scan electrode lines Y₁, . . . , and Yₙ are formed of transparent electrodes Xₙₐ and Yₙₐ formed of indium tin oxide (ITO) and metal electrodes X_{nb} and Y_{nb} for improving conductivity. A plurality of address electrode lines A_{R1}, . . . , and A_{Bm} covered with a direct substance 121 are formed on a second substrate 120. Barrier ribs 122 are formed on the direct substance 121 between the plurality of address electrode lines A_{R1}, . . . , and A_{Bm} in parallel with the address electrode lines A_{R1}, . . . , and A_{Bm}. Fluorescent layers 130 are formed on both sides of the barrier ribs and on the direct substance 121. The first substrate 110 and the second substrate 120 are attached so that the scan electrode lines Y₁, . . . , and Yₙ and the address electrode lines A_{R1}, . . . , and A_{Bm} and the sustain electrode lines X₁, . . . , and Xₙ and the address electrode lines A_{R1}, . . . , and A_{Bm} cross each other to form discharge spaces 140 defined by the barrier ribs 122. The discharge spaces 140 are filled with a gas for forming plasma to be sealed up so that a plurality of pixels are formed.

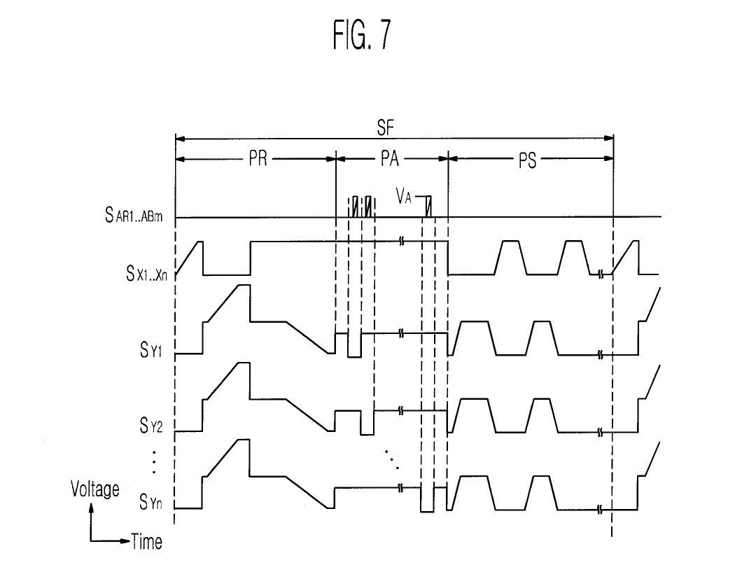

In the plasma display device having the above structure, as illustrated in FIG. 2, a unit frame is time divided into a plurality of subfields SF. In each subfield SF, an initialization period PR, an address period PA, and a sustain discharging period PS are sequentially performed by the voltage waveform of FIG. 7 so that an image having a desired gray scale is displayed on the PDP 100.

First, in the initialization period PR, the wall charges of a pixel in which sustain discharge is performed in a previous subfield are erased and the charge state of each pixel is made substantially uniform so that pixels can be smoothly selected in a next step.

When the initialization period PR is completed, the address period PA for accumulating wall charges in pixels to be driven is performed. In the address period PA, wall charges are accumulated in the pixels to be driven. In the address period PA, scan signals S_{Y1}, . . . , and S_{Yn} are sequentially applied to the scan electrode lines Y₁, and Yₙ and display data signals S_{AR1}, . . . , and S_{ABm} are applied to the address electrode lines A_{R1}, . . . , and A_{Bm} so that wall charges are accumulated in the selected pixels.

That is, the controller 240 generates the control signal S_{A} and the switching signal S_{V} to supply the control signal S_{A} and the switching signal S_{V} to the address driver 230. The switching signal S_{V} is a signal for generating the data voltage V_{A} of a different level. The controller 240 generates the switching signal S_{V} in accordance with the number of sustain pulses included in the sustain discharging period PS of each subfield SF.

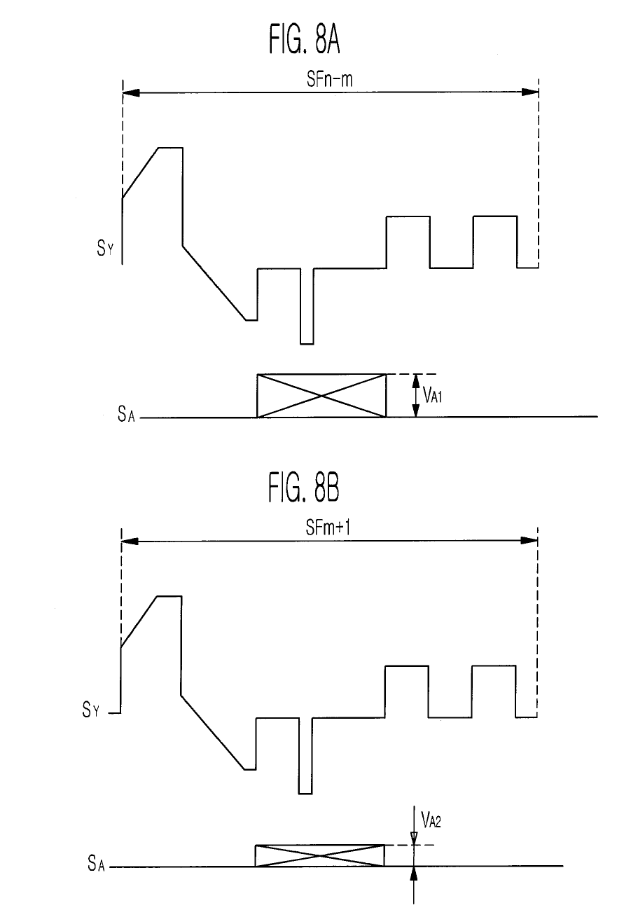

For example, when the unit frame is time divided into first to nth subfields SF, as illustrated in FIGS. 8A and 8B, in the first subfield SF1 to the (n-m)th subfield SFn-m, the switching signal S_{V} for driving the first switching unit S_{W1} is generated. In the (m+1)th subfield SFm+1 to the nth subfield SFn, the switching signal S_{V} for driving the second switching unit S_{W2} is generated (n and m are integers) or the switching signal S_{V} can be generated so that a voltage of a level that is inversely proportional to the number of sustain pulses included in the sustain discharging period PS of each subfield SF is generated.

The address driver 230 generates the data voltages V_{A1} and V_{A2} of different levels by the above-described operation performed in accordance with the switching signal S_{V} to supply the display data signals S_{AR1}, . . . , and S_{ABm} having the voltage V_{A1} or V_{A2} generated in accordance with the control signal S_{A} to the PDP 100.

In the sustain discharging period PS, an image is displayed by the discharge in a selected pixel. In the sustain discharging period PS, sustain pulses having opposite phases are applied to the scan electrode lines Y₁, . . . , and Yₙ and the sustain electrode lines X₁, . . . , and Xₙ so that discharge is sustained in the selected pixels and that the image is displayed.

On the other hand, in the PDP 100, a discharge characteristic can change in accordance with a change in the temperature. In general, when the temperature of the PDP 100 rises, since space charges become active, the space charges are actively recombined with other space charges or wall charges. When the amount of recombination between the space charges and the wall charges increases, since a wall voltage decreases, a discharge voltage increases. Conversely, when the temperature falls, since the amount of recombination between the space charges and the wall charges is dropped so that the wall voltage increases, the discharge voltage decreases.

Therefore, the low data voltage VA is used at a low temperature and the high data voltage VA is used at a high temperature so that the display data having different levels of voltages in accordance with a change in the temperature are supplied to the PDP.

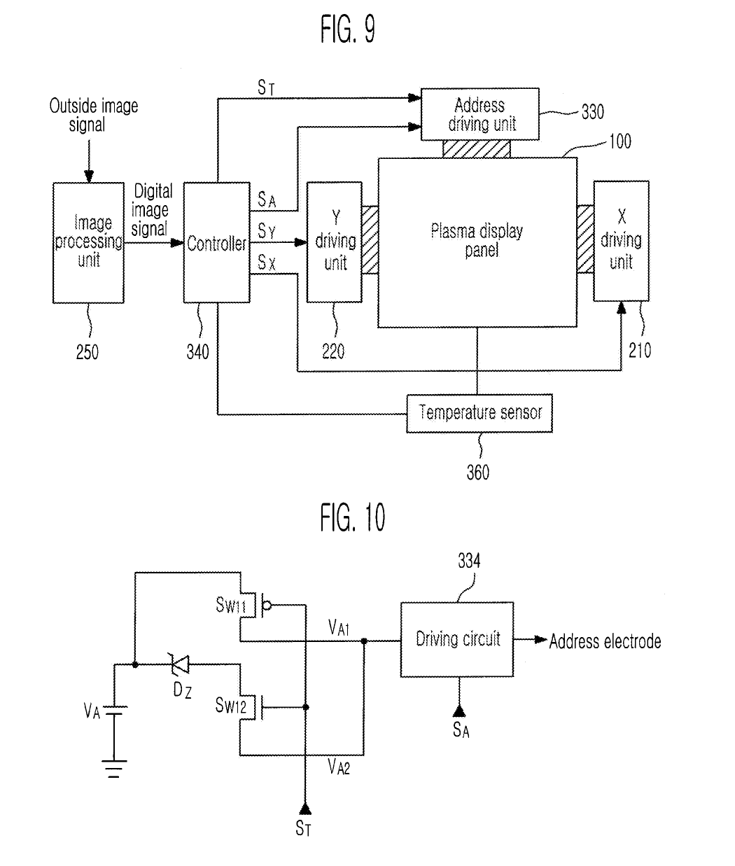

FIG. 9 is a block diagram illustrating a plasma display device according to a second embodiment of the present invention. The plasma display device illustrated in FIG. 9 includes a controller 340, an address driver (i.e., address driving unit) 330, and a temperature sensor 360 that are different from the elements of the plasma display device of FIG. 4.

The temperature sensor 360 senses the temperature of the PDP 100 to output a signal in accordance with the sensed temperature to the controller 340.

The controller 340 receives image data and synchronizing signals from the image processor 250 to time divide a unit frame into a plurality of subfields and outputs the control signals S_{X}, S_{Y}, and S_{A} for dividing each subfield into an initialization period, an address period, and a sustain discharging period to drive the subfields. The controller 340 outputs a switching signal S_{T} for supplying the data voltage V_{A} of a corresponding level in accordance with the temperature sensed by the temperature sensor 360 to the address driver 330.

The address driver 330 processes the control signal S_{A} to apply the display data signals to the address electrode lines. Here, as illustrated in FIG. 10, the address driver 330 supplies the first data voltage V_{A1} or the second data voltage V_{A2} to a driving circuit 334 in accordance with the switching signal S_{T} so that the display data signal having the data voltage V_{A1} or V_{A2} of a corresponding level is applied to the address electrode lines in accordance with the control signal S_{A}.

FIG. 10 is a circuit diagram illustrating the exemplary address driving unit of FIG. 9. Referring to FIG. 10, the address driver 330 includes at least one voltage dropping unit D_{Z} coupled with the voltage source V_{A}, a plurality of switching units (i.e., switches) S_{W11} and S_{W12} coupled with the voltage source V_{A} and the voltage dropping unit D_{Z} to be selectively driven in accordance with the switching signal S_{T}, and the driving circuit 334 that receives the control signal S_{A} to generate the display data signal having the voltage V_{A1} or V_{A2} transmitted through the switching units S_{W11} and S_{W12}. As can be seen in FIG. 10, the switches S_{W11} and S_{W12} in one embodiment are PMOS and NMOS transistors, respectively. In other embodiments, the switches S_{W11} and S_{W12} may be any other suitable type of device as long as they alternately turn on and off.

When the first switching unit S_{W11} is turned on by the switching signal S_{T} supplied by the controller 340, the first data voltage V_{A1} supplied by the voltage source V_{A} is transmitted to the driving circuit 334. When the second switching unit S_{W12} is turned on by the switching signal S_{T}, the second data voltage V_{A2} that is lower than the first data voltage V_{A1} by the Zener voltage dropped by the voltage dropping unit D_{Z} is transmitted to the driving circuit 334. For example, when the temperature sensed by the temperature sensor 360 is higher than a reference temperature, the first switching unit S_{W11} is turned on so that the first data voltage V_{A1} is transmitted to the driving circuit 334. When the temperature sensed by the temperature sensor 360 is lower than the reference temperature, the second switching unit S_{W12} is turned on so that the second data voltage V_{A2} that is lower than the first data voltage V_{A1} is transmitted to the driving circuit 334.

According to the first and second embodiment, the Zener diode is used as the voltage dropping unit D_{Z} and two levels of data voltages V_{A1} and V_{A2} are generated. However, in other embodiments, voltage dropping units having different amounts of voltage drops can be used. For example, data voltages having a difference by a desired level can be generated using a transient voltage suppressor (TVS) diode, a resistor, or a chip type integrated circuit (IC; TL431). Here, the level of the data voltage VA corresponding to each subfield SF or temperature should be determined by the characteristic of the PDP 100.

As described above, the display data having different levels of voltages in accordance with the subfields or the temperature of the PDP are supplied to the PDP so that a substantially uniform discharge margin is sustained and that the inefficient power consumption can be avoided. According to the embodiments of the present invention, when a moving picture or a specific pattern having many address operations is displayed, it is possible to effectively reduce the stress and the inefficient power consumption of the driver. In particular, it is possible to effectively solve the inefficient power consumption problem of high brightness and high definition (HD) displays.

Although exemplary embodiments of the present invention have been shown and described, those skilled in the art would understand that changes might be made in this embodiment without departing from the principles and spirit of the invention, the scope of which is defined in the claims and their equivalents.

What is claimed is:

1. A plasma display device, comprising:
a plasma display panel;
a controller for receiving a digital image signal of an image to be displayed on the plasma display panel during a frame, for time dividing the frame into a plurality of subfields, for generating control signals for driving the plasma display panel during an initialization period, an address period, and a sustain discharging period of each of the plurality of subfields, and for generating switching signals corresponding to respective said subfields; and
a driver for generating different levels of voltages in accordance with the switching signals, and for providing display data of the image with the generated voltages in accordance with the control signals to the plasma display panel.

2. The plasma display device as claimed in claim 1, wherein the plasma display panel comprises pixels formed by a plurality of first electrodes, a plurality of second electrodes, and a plurality of third electrodes, the third electrodes crossing the first and second electrodes.

3. The plasma display device as claimed in claim 1, wherein the controller is configured to generate the switching signals in accordance with a number of sustain pulses to be applied to the plasma display panel during the sustain discharging period of respective said subfields.

4. The plasma display device as claimed in claim 1, wherein the driver comprises:
a voltage source;
at least one voltage dropping unit coupled with the voltage source;
a plurality of switches respectively coupled with the voltage source and the at least one voltage dropping unit, and selectively driven by the switching signals; and
a driving circuit for receiving the control signals and for generating the display data with voltage from the voltage source to be transmitted through the plurality of switches.

5. The plasma display device as claimed in claim 4, wherein the at least one voltage dropping unit has different amounts of voltage drop.

6. The plasma display device as claimed in claim 4, wherein the at least one voltage dropping unit comprises a Zener diode, a transient voltage suppressor (TVS) diode, or a resistor.

7. The plasma display device as claimed in claim 1, wherein a voltage of a level that is inversely proportional to a number of sustain pulses applied to the plasma display panel during the sustain discharging period of each of the plurality of subfields is generated in response to the switching signals.

8. The plasma display device as claimed in claim 1, further comprising an image processor for receiving an analog image signal and for outputting the digital image signal.

9. A method of driving a plasma display device comprising a plasma display panel, the method comprising:
time dividing a frame of a multi-gray level image into a plurality of subfields;
displaying the multi-gray level image by driving the plasma display panel during an initialization period, an address period, and a sustain discharging period of each of the plurality of subfields; and
providing display data of the image with different levels of voltages in accordance with the subfields to the plasma display panel.

10. The method as claimed in claim 9, wherein the voltage levels of the display data are inversely proportional to a number of sustain pulses applied to the plasma display panel during the sustain discharging period of each of the subfields.

11. A method of driving a plasma display device comprising a plasma display panel, the method comprising:
time dividing a frame of a multi-gray level image into first through nth subfields;
displaying the multi-gray level image by driving the plasma display panel during an initialization period, an address period, and a sustain discharging period of each of the first through nth subfields;
providing first display data of the image with a first voltage to first through n-m subfields of the frame to the plasma display panel; and
providing second display data of the image with a second voltage to m+1 through nth subfields of the frame to the plasma display panel.

12. The method as claimed in claim 11, wherein a number of sustain pulses applied to the plasma display panel during the sustain discharging period of the nth subfield is greater than a number of sustain pulses applied to the plasma display panel during the sustain discharging period of the first subfield.

13. The method as claimed in claim 11, wherein the first voltage is higher than the second voltage.

14. A plasma display device, comprising:
a plasma display panel;
a temperature sensor for sensing temperature of the plasma display panel;
a controller for receiving a digital image signal of an image to be displayed on the plasma display panel during a frame, for time dividing the frame into a plurality of subfields, for generating control signals for driving the plasma display panel during an initialization period, an address period, and a sustain discharging period of each of the plurality of subfields, and for generating switching signals corresponding to the temperature sensed by the temperature sensor; and
a driver for generating different levels of voltages in accordance with the switching signals, and for providing display data of the image with the generated voltages in accordance with the control signals to the plasma display panel.

15. The plasma display device as claimed in claim 14, wherein the plasma display panel comprises pixels formed by a plurality of first electrodes, a plurality of second electrodes, and a plurality of third electrodes, the third electrodes crossing the first and second electrodes.

16. The plasma display device as claimed in claim 14, wherein the driver comprises:
a voltage source;
at least one voltage dropping unit coupled with the voltage source;
a plurality of switches respectively coupled with the voltage source and the at least one voltage dropping unit, and selectively driven by the switching signals; and
a driving circuit for receiving the control signals and for generating the display data with voltages to be transmitted through the plurality of switches.

17. The plasma display device as claimed in claim 16, wherein the at least one voltage dropping unit has different amounts of voltage drop.

18. The plasma display device as claimed in claim 16, wherein the voltage dropping unit comprises a Zener diode, a transient voltage suppressor (TVS) diode, or a resistor.

19. The plasma display device as claimed in claim 14, further comprising an image processor for receiving an analog image signal and for outputting the digital image signal.

20. A method of driving a plasma display panel, comprising:
sensing temperature of the plasma display panel; and
providing display data with voltages of different levels in accordance with the sensed temperatures to the plasma display panel.

21. The method of driving a plasma display panel as claimed in claim 20, wherein first display data with a first voltage is provided to the plasma display panel when the sensed temperature is less than or equal to a reference temperature, and second display data with a second voltage that is higher than the first voltage is provided to the plasma display panel when the sensed temperature is greater than the reference temperature.
